(19) United States
(12) Patent Application Publication
(10) Pub. No.: US 2007/0085004 A1
(43) Pub. Date: Apr. 19, 2007

(54) Substrate-examining apparatus

(76) Inventors: Kusuo Ueno, Tokyo (JP); Masuo Anma, Tokyo (JP)

Correspondence Address: KUBOVCIK & KUBOVCIK, SUITE 710, 900 17TH STREET NW, WASHINGTON, DC, 20006, US

(21) Appl. No.: 11/390,556

(22) Filed: Mar. 28, 2006

(30) Foreign Application Priority Data
Sep. 30, 2005 (JP) 2005-286917

(51) Int. Cl. G21K 7/00

(52) U.S. Cl. 250/310

(57) ABSTRACT

The invention provides a substrate-examining apparatus which is capable of measuring the detailed shape of a contact hole and the state of a hole bottom. A substrate-examining apparatus includes an electron source (21) for generating an electron beam, a deflector (22) for irradiating a surface of a substrate to be examined with the electron beam from the electron source so as to scan the electron beam, and substrate current detecting means for detecting a current caused to flow from the substrate to a reference potential portion of the apparatus. This apparatus characteristically includes an arithmetic operation processor (50), based on a deflection signal from the deflector (22) and a signal of the detected substrate current, for extracting a substrate current signal from a contact hole portion and a substrate current signal from a portion other than the contact hole portion from the signal of the detected substrate current, calculating amounts of respective currents, thereby displaying a state of the contact hole.

### BACKGROUND OF THE INVENTION

The present invention relates to a substrate-examining apparatus, such as a scanning electron microscope or a semiconductor evaluating apparatus, which has means for scanning a substrate as a sample with an electron beam to detect charged particles generated from the substrate by a detector, thereby forming a sample image based on information from a synchronous signal generator.

Heretofore, a substrate-examining apparatus such as a semiconductor evaluating apparatus has been known which scans a sample with an electron beam deflected by a deflector to detect charged particles generated from the sample by a detector, and forms a sample image based on information from a scanning synchronous signal generator. Examples of such a substrate-examining apparatus include one which includes means for measuring a substrate current generated from a substrate in order to evaluate a shape of a contact hole, and a state of a hole bottom in the substrate based on the substrate current signal.

JP-A 2003-214831 describes a film thickness measuring apparatus. In this film thickness measuring apparatus, a thin film as an object to be measured that is formed on a substrate is irradiated with an electron beam, and a value of substrate current is measured which is caused to flow through the substrate during the irradiation. Then, the substrate current value is corrected in consideration of an influence of a distribution of charges generated in the vicinity of the thin film by the irradiation of the electron beam, or a substrate surface shape in the vicinity of the thin film. Thus, reference data indicating the relationship between a film thickness and a substrate current in a standard sample is acquired. Then, a film thickness of the thin film as the object to be measured is calculated based on the substrate current value corrected.

Also, JP-A 2003-214832 describes a film thickness measuring apparatus. In this film thickness measuring apparatus, a thin film, an object to be measured, which is formed on a substrate is irradiated with an electron beam with first energy and an electron beam with second energy. A value of first substrate current caused to flow through the substrate when the thin film is irradiated with the electron beams with the first energy, and a value of second substrate current caused to flow through the substrate when the thin film is irradiated with the electron beams with the second energy are measured. Thus, reference data is acquired which indicates the relationship between a reference function having the substrate current obtained by irradiating the thin film with the electron beams with the first energy and the substrate current obtained by irradiating the thin film with the electron beams with the second energy as variables, and a film thickness. Then, a film thickness of the thin film as the object to be measured is calculated based on the first and second substrate currents in consideration of the reference data.

JP-A 2003-303867 describes a contact hole inspecting method including area measuring processing, comparison measuring processing, and single measuring processing. In the area measuring processing, a mean absorption current (sample current) in each area on a wafer is measured while the wafer is two-dimensionally scanned with a focused charged particle beam to obtain an absorption current intensity distribution diagram over the entire area of the wafer. In the comparison measuring processing, a secondary electron image and an absorption current image are measured in an area that is suitably selected from its view thereon, and both the images are compared with each other to specify a contact hole having defective contact. Also, in the single measuring processing, an absorption current is measured by irradiating the specified defective contact hole with a focused charged particle beam to obtain a thickness of a remaining film in the contact hole concerned.

In addition, JP-A 2005-244218 describes a substrate measuring apparatus including a reference value storing portion, a current measuring portion, and a characteristic value calculating portion. The reference value storing portion stores therein a characteristic value of a contact hole formed through a dielectric film on a substrate, and a value of current caused to flow through the substrate when the substrate to be examined is irradiated with electrons, with the characteristic value and the current value associated with each other. The current measuring portion measures a value of current caused to flow through the substrate to be inspected when the substrate to be inspected is irradiated with electrons. Also, the characteristic value calculating portion calculates a characteristic value of the contact hole in the substrate to be inspected by utilizing the current value measured in the substrate to be inspected, and the characteristic value and the current value which are stored in the reference value storing portion.

However, in the contact hole measurement by the conventional substrate-examining apparatus such as the scanning electron microscope or the semiconductor evaluating apparatus, it is difficult to stably perform examination and measurement of a hole bottom of the contact hole due to charge-up resulting from the quality of film on a sample or the like. Moreover, there is encountered a problem in that it cannot be detected whether or not a residue is left in a specific hole bottom.

In the light of the foregoing, it is an object of the present invention to provide a substrate-examining apparatus which is capable of measuring a detailed contact hole shape, and a state of a hole bottom of the contact hole.

### SUMMARY OF THE INVENTION

A substrate-examining apparatus according to the present invention includes arithmetic operation means in order to obtain detailed information on a contact hole based on a scanning signal and a substrate current signal which is directly detected from a substrate.

That is to say, a substrate-examining apparatus of the invention includes an electron source for generating an electron beam, deflecting means for deflecting the electron beam from the electron source to scan a substrate to be examined with the deflected electron beam, substrate current detecting means for detecting a current from a substrate, and arithmetic operation means, based on a deflection signal from the deflecting means and a signal of the detected substrate current, extracting a substrate current signal from a contact hole portion and a substrate current signal from a portion other than the contact hole portion from the signal of the detected substrate current, calculating amounts of respective currents, and thereby displaying a state of the contact hole.

Preferably, the arithmetic operation means may include hole diameter calculating means for calculating a diameter of a hole bottom portion and a diameter of an upper end portion in the contact hole portion.

In addition, preferably, the arithmetic operation means may include current amount arithmetic operation means for subtracting an amount of current obtained from the substrate current signal from the portion other than the contact hole portion from an amount of current obtained from the substrate current signal from the contact hole portion to obtain a resulting difference as an amount of true current from the contact hole portion.

Moreover, preferably, the arithmetic operation means may include identification arithmetic operation means for identifying a flat surface portion of a periphery of the contact hole, a hole opening portion of an upper end of the contact hole, a hole wall portion, and a hole bottom portion of the contact hole from the substrate current signal from the contact hole portion.

Furthermore, preferably, the substrate-examining apparatus may further include an amplifier for amplifying the substrate current signal. Also, the substrate-examining apparatus may further include an image display device for displaying thereon a scanning image based on charged particles generated from the substrate.

That is to say, according to the substrate-examining apparatus of the present invention, the shape of the contact hole, and a state of the hole bottom of the contact hole can be precisely examined and evaluated based on the charged particle signal from the substrate as the sample, and the substrate current signal directly detected from the substrate.

### BRIEF DESCRIPTION OF THE DRAWINGS

FIG. 1 is a block diagram showing the overall construction of a substrate-examining apparatus according to an embodiment of the present invention;

FIGS. 2A, 2B and 2C are diagrams each showing an example of a SEM image of a substrate contact hole;

FIG. 3 is a waveform chart showing a substrate current signal obtained by scanning a contact hole by way of example;

FIG. 4 is a waveform chart explaining an example of the substrate current signal for calculation of an amount of current from a contact hole portion and an amount of current from a portion other than the contact hole portion;

FIG. 5 is a waveform chart showing an example of processing the substrate current signal for the calculation of an amount of current from the contact hole portion and an amount of current from the portion other than the contact hole portion;

FIG. 6 is a waveform chart showing a correspondence among a hole bottom diameter, an upper end diameter, and the substrate current signal when diameters of the hole bottom and the upper end of the contact hole are calculated;

FIG. 7 is a waveform chart showing an example of dividing an original signal of the substrate current into classes;

FIGS. 8A and 8B are diagrams each showing linear approximation after processing for dividing the original signal of the substrate current into classes; and

FIG. 9 is a waveform chart showing an example of a substrate current signal obtained by scanning a contact hole.

### DETAILED DESCRIPTION OF PREFERRED EMBODIMENTS

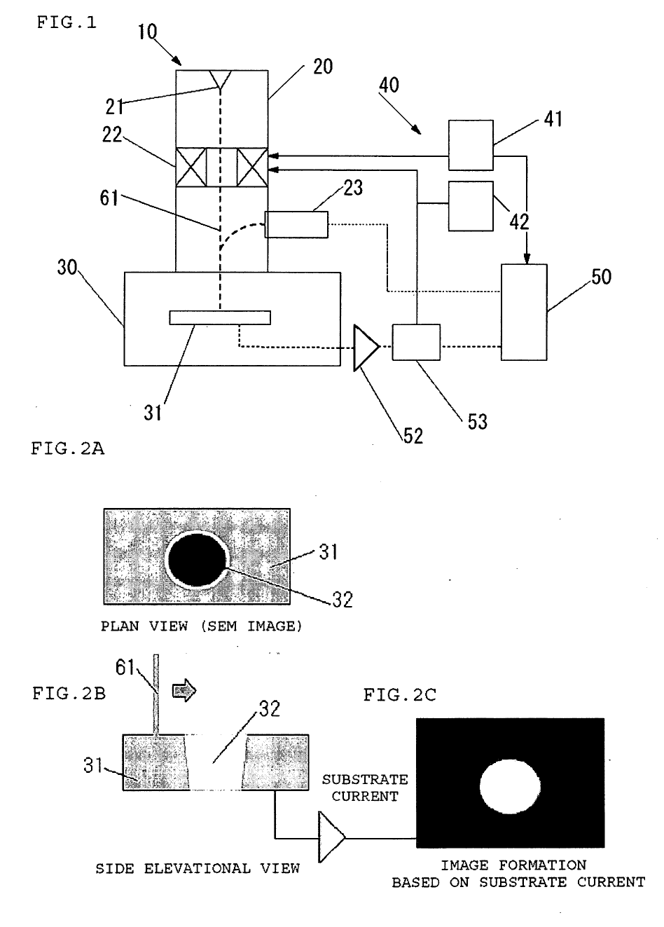

A preferred embodiment of a substrate-examining apparatus according to the present invention will hereinafter be described in detail with reference to the accompanying drawings. FIG. 1 shows an outline of an overall construction of a substrate-examining apparatus according to an embodiment of the present invention.

A substrate-examining apparatus 10 according to this embodiment of the present invention includes a lens barrel 20 and a sample chamber 30. An electron source 21, a deflector 22, a convergent lens (not shown), and a detector 23 are provided inside the lens barrel 20. The electron source 21 generates an electron beam. The deflector 22 deflects the electron beam generated from the electron source 21 in a predetermined direction. Also, the detector 23 detects a reflected electron beam, a secondary electron beam, and charged particles. In addition, a sample stage on which a sample 31 is placed is disposed in the sample chamber 30.

The deflector 22 is deflection-controlled by a control system 40 which is provided with a deflection width setting unit 41, and a synchronous signal generator 42.

A signal from the detector 23 is subjected to arithmetic operation in an arithmetic operation processor 50 including an arithmetic operation function, a memory function, and a display function. In addition, a substrate current signal from the sample 31 is inputted to the arithmetic operation processor 50 through an amplifier 52 and an A/D converter 53. A deflection width signal from the deflection width setting unit 41 is also inputted to the arithmetic operation processor 50. In this embodiment, the arithmetic operation processor 50 includes a CPU, a ROM, and a RAM, which are not shown. The arithmetic operation processor 50 performs functions of diameter calculating means, current amount arithmetic operation means, and identification arithmetic operation means in accordance with a program which is previously stored. The diameter calculating means calculates the respective diameters of a hole bottom portion and an upper end portion included in a contact hole portion on the basis of the signal of the substrate current. The current amount arithmetic operation means subtracts an amount of current obtained from a substrate current signal from a portion other than the contact hole portion from an amount of current obtained from the substrate current signal from the contact hole portion to obtain a resulting difference as an amount of true current from the contact hole portion. Also, the identification arithmetic operation means identifies a flat surface portion of the periphery of the contact hole, and a hole opening edge portion of an upper end, a hole wall portion and a hole bottom portion of the contact hole on the basis of the substrate current signal from the contact hole portion. Substrate current detecting means includes the amplifier 52, the A/D converter 53 and the arithmetic operation processor 50. The substrate current detecting means detects a current flowing from the substrate to a reference potential portion (ground).

In addition, a storage device and a display device such as a monitor are installed in the arithmetic operation processor 50. The storage device stores therein a substrate current signal, a deflection signal from the deflector 22, a synchronous signal and the like. The display device displays thereon a sample image of the substrate 31 based on a detection signal from the detector 23 for detecting the secondary electrons and the like.

The deflection width signal from the deflection width setting unit 41 is inputted to the deflector 22 and the A/D converter 53. In addition, the synchronous signal from the synchronous signal generator 42 is inputted to the deflector 22 and the arithmetic operation processor 50.

In this embodiment, the electron beam generated from the electron source 21 is deflected in a predetermined direction by the deflector 22, and is directed to a wafer substrate as the sample 31, thereby examining a contact hole and the like on the wafer substrate.

The deflection width setting signal used to set a deflection width is inputted from the deflection width setting unit 41 to the deflector 22. At the same time, the deflection width setting signal is inputted from the deflection width setting unit 41 to the arithmetic operation processor 50.

The detector 23 detects the charged particles such as the secondary electrons and the reflected electrons which are generated from the contact hole and the like of the wafer substrate. The arithmetic operation processor 50 forms a sample image (a scanning electron microscope image, i.e., a SEM image) based on the resulting detection signal, and displays the sample image for examination. It is evaluated based on the displayed contents whether or not the contact hole made in the wafer substrate is formed according to specifications.

Next, a description will be given of processing executed when the contact hole is examined in this embodiment. Hereinafter, a description will be made of measurement of the contact hole shown in FIG. 2A by way of example.

As shown in FIG. 2B, when the electron beam 61 is scanned so as to cross the contact hole 32 of the sample 31, a SEM image of the contact hole is observed as shown in FIG. 2C. The contact hole image can also be formed from a substrate current by using the same synchronous signal as that of the SEM image. Here, the substrate current is detailed: a large amount of current is obtained in the contact hole portion of this sample, while a small amount of current is obtained in a portion other than the contact hole portion thereof. The contact hole is measured by using this signal.

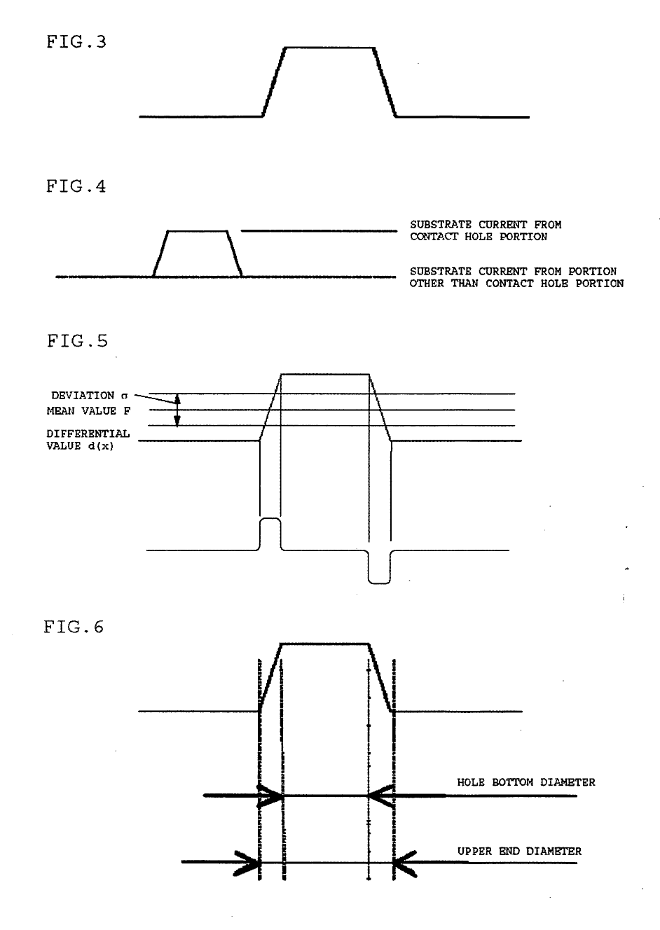

Next, a description will be given of processing for the substrate current signal in the arithmetic operation processor 50. The substrate current signal obtained by scanning the contact hole with the electron beam is extracted and separated into a part from the contact hole portion and a part from the portion other than the contact hole portion for calculating the respective associated amounts of current. A method of calculating the amounts of current is as below. Part of the substrate current signal obtained by scanning the contact hole with the electron beam is expressed for example as shown in FIG. 3.

This signal is subjected to arithmetic operation to calculate an amount of current from the contact hole portion and an amount of current from the portion other than the contact hole portion as shown in FIGS. 4 and 5. A technique as will be described below can be adopted for the actual calculation of the amounts of respective currents. Here, the substrate current from the contact hole portion is assigned E_{CH}, the substrate current from the portion other than the contact hole portion is assigned E_{Base}, and an original signal is assigned f(x).

Step 1: a mean value F and a deviation a are obtained for the original signal f(x).

Step 2: the original signal f(x) is subjected to differential processing, and its result is assigned d(x).

Step 3: classification is executed in the manner as will be described below to calculate the substrate currents E_{CH} and E_{Base}.

Firstly, a total sum of currents (Σf(x)) is obtained for x fulfilling a condition of d(x)<σ and f(x)<F. This value, Σf(x), becomes equal to the substrate current E_{Base} from the portion other than the contact hole of the sample.

That is to say, the following expression is obtained:
E_{Base}=Σf(x)

In addition, a total sum of current (Σf(x)) is obtained for x fulfilling a condition of d(x)<σ and f(x)>F. This value, Σf(x), becomes equal to the substrate current E_{CH} from the contact hole of the sample.

That is to say, the following expression is obtained:
E_{CH}=Σf(x)

Next, diameters of a hole bottom and an upper end of the contact hole are calculated by the arithmetic operation processor 50. That is to say, the diameters of a hole bottom portion and an upper end portion of the contact hole portion are calculated based on the substrate current signal obtained by scanning the contact hole. The calculating method using the arithmetic operation means is as below.

Part of the substrate current signal obtained by scanning the contact hole is expressed as shown in FIG. 3, for example, similarly to the above-mentioned calculation example. This signal is subjected to arithmetic operation to calculate the respective diameters of the hole bottom portion and upper end portion of the contact hole portion shown in FIG. 6.

A technique as will be described below can be adopted for the actual calculation of the diameters. In this calculation example, the substrate current from the contact hole is assigned E_{CH} and the substrate current from the portion other than the contact hole is assigned E_{Base}, and in this state, the diameters of the contact hole portion is calculated.

In addition, the original signal is assigned f(x), the diameter of the hole bottom is assigned W_{CH}, and the diameter of the upper end is assigned W_{Base}.

In the above-mentioned calculation example, the original signal f(x) is classified into only the substrate currents E_{CH} and B_{Base}. In this calculation example, however, f(x) is further classified as below under conditions other than the above-mentioned conditions:

x fulfilling the conditions of d(x)>σ and d(x)<0 is assigned S_{Right}, and

x fulfilling the conditions of d(x)>σ and d(x)>0 is assigned S_{Left}.

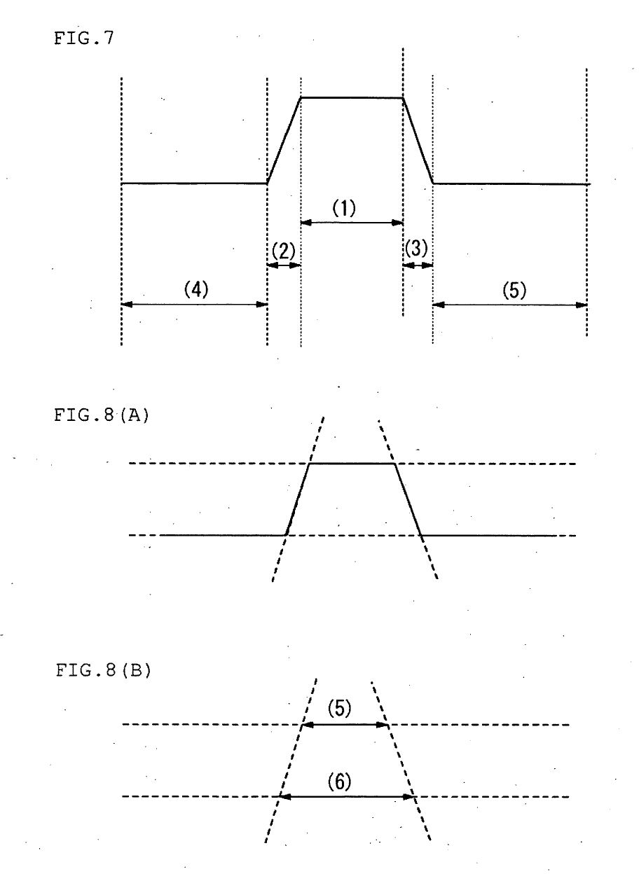

The original signal f(x) is classified based on such classification processing as shown in FIG. 7.

(1): A range in which the original signal f(x) is classified into E_{CH}

(2): A range in which the original signal f(x) is classified into S_{Left}.

(3): A range in which the original signal f(x) is classified into S_{Right}.

(4): A range in which the original signal f(x) is classified into E_{Base}.

Here, the ranges (1) to (4), as shown in FIG. 8A, are approximated by straight lines, respectively. Then, a distance (5) between an intersection of the approximation straight lines of the regions (1) and (2), and an intersection of the approximation straight lines of the regions (1) and (3) can be calculated as W_{CH}. Also, a distance (6) between an intersection of the approximation straight lines of the regions (4) and (2), and an intersection of the approximation straight lines of the regions (4) and (3) can be calculated as W_{Base}.

From the above, similarly to the above-mentioned calculation example, amounts of currents from the respective portions can be calculated, and the sizes thereof can be calculated.

In addition, the original signal f(x) can be classified into the flat surface portion (4) of the periphery of the contact hole, the hole portion ((1)+(2)+(3)) of the upper end, the hole cylinder portion (2), (3), and the hole bottom portion (1) based on the substrate current signal from the contact hole portion. Also, while the approximation straight lines are used, a section shape of the contact hole can be displayed on the display device. As a result, it can be precisely evaluated whether or not the contact hole made through the etching process is accurately formed according to the specifications.

In addition, in this embodiment, even when the original signal contains signals about a plurality of contact holes, processing for checking whether or not the contact holes are arranged so as to agree with the order expected from the shapes of the contact holes may be added. In this case, the measurement of the substrate current E_{CH} from the contact hole portion, and the measurement of the hole diameter of the upper end and the diameter of the hole bottom portion in the contact hole become possible for the individual contact holes. The addition of this processing makes it possible to measure all the contact holes obtained from the original signal, and measure the specific contact hole, e.g., the contact hole nearest the center of a screen.

Meanwhile, the resulting substrate current signal is influenced by the charge due to the irradiation of the electron beam. An amount of substrate current from the contact hole will be changed due to the charge. As has been shown in this embodiment, not only an amount of substrate current from the contact hole portion, but also an amount of substrate current from the portion other than the contact hole portion are obtained. The difference between them is taken as an amount of current from the contact hole portion, thereby allowing the influence of the charge to be reduced. That is to say, in the case of the charge-up, the overall surface of the substrate is charged with electricity, and both the substrate currents E_{CH} and E_{Base} are changed by the same amount of current. Hence, a depth shape of the contact hole can be obtained from the substrate currents E_{CH} and E_{Base}. This is taken into consideration when the contact hole is evaluated.

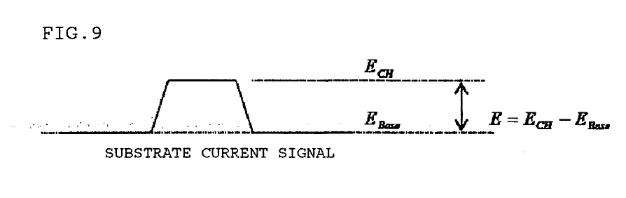

For example, part of the substrate current signal which is obtained by scanning the contact hole is as shown in FIG. 9. In this example, as has been described in this embodiment, the substrate current from the contact hole is assigned E_{CH} and the substrate current from the portion other than the contact hole is assigned E_{Base}, and in this state, the calculation is carried out. Here, when there is an influence of the charge, both the substrate currents E_{CH} and E_{Base} are increased or decreased by the same amount of current. In other words, in order to calculate the substrate current E from the contact hole which is free from the influence of the charge, a difference between the substrate currents E_{CH} and E_{Base} is obtained.

What is claimed is:

1. A substrate-examining apparatus comprising:
an electron source for generating an electron beam;
deflecting means for irradiating a surface of a substrate to be examined with the electron beam from said electron source so as to scan the electron beam;
substrate current detecting means for detecting a current caused to flow from said substrate to a reference potential portion of said substrate-examining apparatus; and
arithmetic operation means, based on a deflection signal from said deflecting means and a signal of the detected substrate current, for extracting a substrate current signal from a contact hole portion and a substrate current signal from a portion other than said contact hole portion from the signal of the detected substrate current, calculating amounts of respective currents, and thereby displaying a state of said contact hole.

2. A substrate-examining apparatus according to claim 1, wherein said arithmetic operation means comprises hole diameter calculating means for calculating a diameter of a hole bottom portion and a diameter of an upper end portion in said contact hole portion on the basis of the substrate current signal.

3. A substrate-examining apparatus according to claim 2, wherein said arithmetic operation means comprises current amount arithmetic operation means for subtracting an amount of current obtained from the substrate current signal from said portion other than said contact hole portion from an amount of current obtained from the substrate current signal from said contact hole portion to obtain a resulting difference as an amount of true current from said contact hole portion.

4. A substrate-examining apparatus according to claim 3, wherein said arithmetic operation means comprises identification arithmetic operation means for identifying a flat surface portion of a periphery of said contact hole, a hole opening portion of an upper end of said contact hole, and a hole wall portion, and a hole bottom portion of said contact hole from the substrate current signal of said contact hole portion.

5. A substrate-examining apparatus according to claim 4, further comprising an amplifier which amplifies the substrate current signal.

6. A substrate-examining apparatus according to claim 1, further comprising an image display device which displays thereon a scanning image based on charged particles generated from said substrate.
